(19) United States
(12) Patent Application Publication
(10) Pub. No.: US 2018/0220105 A1
(43) Pub. Date: Aug. 2, 2018

(54) SMART PORTABLE ORIENTATION DEVICE

(71) Applicant: WIPRO Limited, Bangalore (IN)

(72) Inventors: Vijay KUMAR, Bangalore (IN); Thomas Chittakattu NINAN, Angadikadavu PO (IN)

(21) Appl. No.: 15/463,787

(22) Filed: Mar. 20, 2017

(30) Foreign Application Priority Data
Feb. 1, 2017 (IN) 201741003800

(51) Int. Cl. H04N 7/18; H04N 5/232

(52) U.S. Cl. CPC H04N 7/183; H04N 5/23293

(57) ABSTRACT

The present disclosure discloses a portable orientation device for a fastener. The portable orientation device comprises a base member having at least one cut-out, to receive the fastener. An indicator having a pointer is provisioned, on the base member such that, the pointer displaces within the indicator based on orientation of the fastener. The portable orientation device also includes one or more image capturing units, configured on the base member to capture data based on movement of the pointer. The one or more image capturing units are interfaced with control unit. The control unit receives the data from the one or more image capturing units, and determines position of the pointer, to enable an operator for orienting the fastener. The portable orientation device enables the user to orient the fastener and connect two or more components for a stress-failure free securement.

### TECHNICAL FIELD

Present disclosure generally relates to field of sensors. Particularly, but not exclusively the present disclosure relates to an orientation device for a fastener. Further embodiments of the present disclosure, discloses a portable orientation device for positioning and orienting a fastener on a surface.

### BACKGROUND

Fastening is a process which may be commonly used in myriad of applications, where two or more components are to be secured. A fastener enables an operator to non-destructively associate, as well as disassemble two or more components, with minimal effort. While the fastener provides a rigid axial-connection between the two or more components, the fastener also restricts the two or more components from undergoing pivotal movement.

In general, fastening process involves creating or making at least one receiving hole or an opening on the surface of the two or more components such that, the fastener is inserted through the at least one receiving hole and fastened by a torque tool for securement. However, the fastener needs to be precisely oriented over the at least one receiving hole, prior to the fastening process. In some occasions, the fastener may be oriented incorrectly during initiation of fastening, and hence, the securement formed between the two or more components may be subjected to stress. Incorrect orientation of the fastener relates to angular placement of the fastener against angle of the at least one receiving hole. In other scenarios, a threaded fastener may misalign with a threaded fastening hole, which may lead to wrong threading or misaligned threading of the fastener. The fasteners at the securement points may be induced with various stress such as, fatigue load stress, shear stress and the like, which may result in failure of the securement, thereby affecting the mechanism and the structure in which the two or more components are secured. Hence, a skilled operator is required to orient or align the fastener on the surface of the two or more components, for achieving a stress-failure free securement.

Conventional self-aligning fasteners may include a support member, which may be configured around the fastener for guiding the fastener in to the hole on the fastening surface. The support member may restrict the fastener from bending or tilting. However, the support member is not reusable, and is fixed to the fastener, post-fastening. In addition, each fastener may be provided with an individual support member, for orienting the fastener. The cost of the support member may be added to the expenses of the fastener. Additionally, spirit level or bubble level may be utilized to determine positioning angle of the fastener. However, the spirit level cannot be placed on the head of the fastener as they are bulky, and cannot be incorporated into each of the fastener.

In general, there may be situations and scenarios such as, but not limited to, construction and fabrications, deep-sea architectures, and other applications of similar genre, where the operator may utilize the assistance of robots for securing the fasteners. In such situations, the operator may not be able to comprehend the position of the fastener with reference to the fastening surface, and thereby causing an incorrect securement, in the construction or assembly. This incorrect securement may be vulnerable to stress, and in turn fail over a period of time, which may lead to catastrophic accidents.

### SUMMARY

One or more shortcomings of the conventional fastening process are overcome and additional advantages are provided through the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a portable orientation device for a fastener is disclosed. The portable orientation device includes a base member, provisioned with an at least one cut-out, to receive the fastener. An indicator is provisioned on the base member, the indicator includes a pointer such that, the pointer displaces within the indicator based on orientation of the fastener. Further, one or more image capturing units are configured on the base member such that the one or more image capturing units captures data based on movement of the pointer. Additionally, a control unit is interfaced to the one or more image capturing units, to receive the data on movement of the pointer from the one or more image capturing units such that, the control unit determines position of the pointer, to enable an operator for orienting the fastener.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 shows a schematic representation of a portable orientation device in accordance

with some embodiments of the present disclosure.

FIG. 2 shows a perspective view of an indicator in accordance with some embodiments of the present disclosure.

FIG. 3 shows an exemplary embodiment of the portable orientation device in accordance with some embodiments of the present disclosure.

FIG. 4 shows another embodiment of the portable orientation device in accordance with some embodiments of the present disclosure.

It should be appreciated by those skilled in the art that any block diagrams herein represent conceptual views of illustrative device embodying the principles of the present subject matter. Similarly, it will be appreciated that any flow charts, flow diagrams, state transition diagrams, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, hut on the contrary, the disclosure is to cover all modifications, equivalents, and alternative falling within the spirit and the scope of the disclosure.

The terms “includes”, “comprising”, or any other variations thereof, are intended to cover a non-exclusive inclusion, such that device or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

The present disclosure discloses a portable orientation device for a fastener. In an embodiment, the portable orientation device may be configured to the fastener, and displaces according to the tilt of the fastener with respect to a surface used for fastening. The configuration of the portable orientation device for the fastener in the present disclosure overcomes some of the problems including dependency on skill of operator for orienting the fastener on the surface used for fastening.

The portable orientation device of the present disclosure includes a base member, to enable an operator to accommodate and configure a fastener, for determining orientation of the fastener with a surface used for fastening. The portable orientation device further includes an indicator, provisioned on the base member, which is associated to a control unit. In an exemplary embodiment, the indicator is an enclosed vial, of a predetermined shape to contain a predefined volume of a liquid or fluid. In some embodiment, the enclosed vial may be of myriad of shapes, such as but not limited to, cuboidal, cubical, cylindrical, spherical, hemispherical, and the like. The predefined volume of liquid, within the enclosed vial, is filled in such that, an air bubble is formed within the enclosed vial. In an embodiment, the predefined volume of liquid may be an electrically conductive and non-adhesive liquid such as alcohol, colored spirit, a liquid colorant and the like. In some embodiment, the air bubble within the enclosed vial may be construed as a pointer, and the pointer may displace within the indicator synchronous to the tilt of the fastener. The indicator further includes an electrical touch sensitive surface, provisioned to detect and track movement of the pointer within the indicator. The control unit associated to the indicator, records and determines the position of the pointer, to enable the operator to orient the fastener on the surface used for fastening.

In an embodiment, the fastener is positioned on the surface used for fastening, corresponding to the displaced position of the pointer within the indicator, and may be detected by the electrical touch sensitive surface of the indicator. In some embodiment, the electrical touch sensitive surface of the indicator may be configured to the control unit, to transmit an input data relating to position of the pointer. The control unit, receives input data on the position of the pointer and determines the position of the pointer. The control unit upon receipt of input data, generates an output signal, due to the displacement of the pointer on the electrical touch sensitive surface. In some embodiment, the output signal generated by the control unit is transmitted to a display unit. In an embodiment, the control unit may be associated to an external display unit, through a connecting unit provisioned in the portable orientation device for determining position of the pointer.

In an embodiment, upon orientation of the fastener on the surface used for fastening, the fastener may be operated by a fastening tool or torque tool to a predefined depth into the fastening surface. Once the fastener is fastened to the predefined depth, the portable orientation device may be detached from the fastener, and the fastening operation may be completed.

In the following detailed description of the embodiments of the disclosure, reference is made to the accompanying figures that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1 shows a schematic representation, illustrating components of a portable orientation device 100, for orienting a fastener 101 with respect to the surface used for fastening in accordance with some embodiments of the present disclosure.

In an exemplary implementation, the portable orientation device 100 includes a base member 102 provisioned to accommodate a fastener 101 through an at least one cut-out 103. The base member 102 further includes an indicator 104 associated to a control unit 107 and a power source 113 which supplies power to the indicator 104 and the control unit 107. In an embodiment, the indicator 104 and the control unit 107 may be configured on an electronic circuit board 112, which operatively connects the indicator 104, the control unit 107 to the power source 113.

As shown in FIG. 1, the portable orientation device 100 is configured to the fastener 101, for detecting orientation of the fastener 101. In an embodiment, the portable orientation device 100 is provided with the base member 102 provisioned with the at least one cut-out 103. The at least one cut-out 103 of the base member 102 facilitates in accommodating the fastener 101 to the portable orientation device 100. On accommodating the fastener 101 to the base member 102, the fastener 101 is placed on the surface to be fastened. Since the fastener 101 is accommodated on the base member 102 of the portable orientation device 100, orientation of the fastener 101 is synchronous with the orientation of the base member 102 and vice-versa. The indicator 104 is mounted on the base member 102 such that, a pointer 105 within the indicator 104 enables the operator to detect orientation of the portable orientation device 100, and in ton that of the fastener 101. In some embodiments of the present disclosure, the pointer 105 displaces within the indicator 104 and assists the operator to identify the orientation of the fastener 101 with respect to the reference axes X-Y. Further, as shown in FIG. 1, the indicator 104 is communicatively coupled to the control unit 107 such that, movement of the pointer 105 is detected by the indicator 104. In some embodiments of the present disclosure, the indicator 104 is configured with an electrical, touch sensitive surface such that, the displacement of the pointer 105 over the electrical touch sensitive surface triggers a signal which is then transmitted to the control unit 107. The control unit 107 determines the position of the pointer 105 within the indicator 104, and records the position of the pointer 105 in order to indicate orientation of the fastener 101 to the operator.

In some embodiments of the present disclosure, the control unit 107 may be associated with a display unit 108 to indicate position of the pointer 105 to the operator. The display unit 108 may indicate position of the pointer 105 with respect to the reference axes X-Y. The reference axes X-Y may be provisioned with a reference point P about which the operator adjusts the orientation of the fastener 101 on the surface used for fastening. Once the pointer 105 positioned on the reference axes X-Y coincides with the reference point P, the operator is indicated by the control unit 107 regarding appropriate orientation of the fastener 101 via visual and audio means. In an embodiment, the operator manually orients the fastener 101, and the fastener 101 may be operated to a predefined depth into the surface used for fastening. Once the fastener 101 is fastened to the predefined depth, the portable orientation device 100 may be detached from the fastener 101, to complete the fastening operation.

In some embodiment, the base member 102 may be made from a flexible material including, but not limited to, polymers, elastomers and the like. The at least one cut-out 103 provided in the base member 102 may be adjusted to accommodate varying shapes of the fastener 101. In some embodiment, the electronic circuit board 112 may be configured to accommodate the display unit 108 for viewing the displacement of the pointer 105 within the indicator 104 by the operator. In some embodiment, the electronic circuit board 112 may be at least one of a Printed Circuit Board (PCB), a perforated circuit board, a bread board, an integrated circuit and the like.

In some embodiment, at least one power source 113 may be associated to the electronic circuit board 112 for supplying power to the components of the portable orientation device 100 such as the indicator 104, the control unit 107 and the display unit 108. The at least one power source 113 may be a lithium-ion battery, a zinc-cadmium battery, a lead acid battery, a nickel-cadmium battery, and any other battery that serves the purpose of supplying power to the portable orientation device 100.

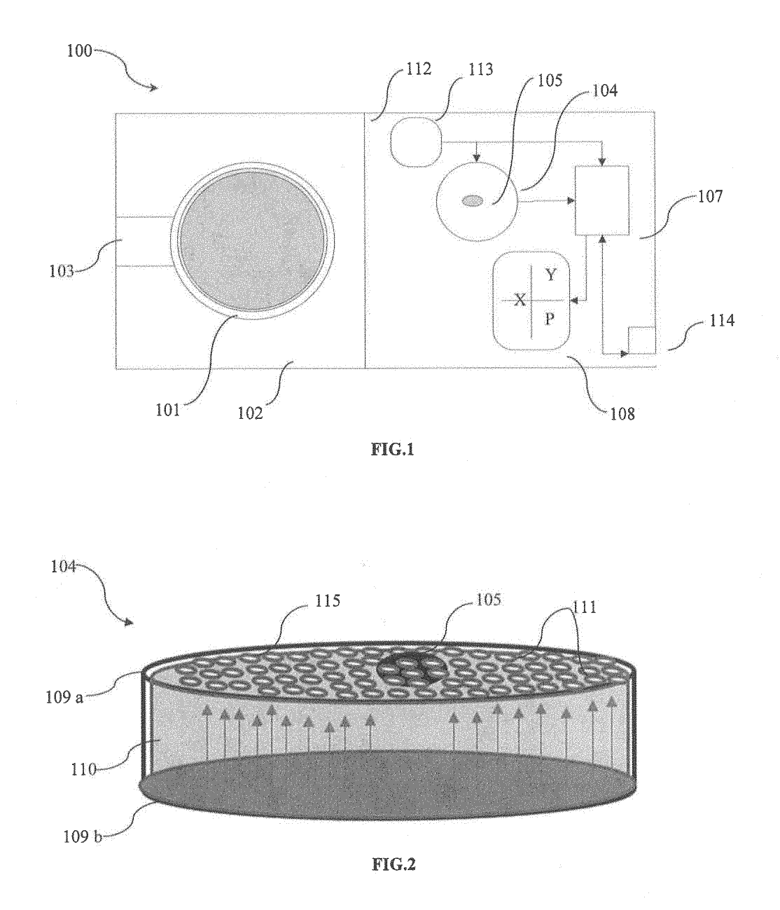

Referring to FIG. 2, the indicator 104 in accordance with some embodiments of the present disclosure may be an enclosed vial comprising a predefined volume of liquid 110. In some embodiment, the enclosed vial may be of myriad of shapes, such as but not limited to, cuboidal, cubical, cylindrical, spherical, hemispherical, and the like. In an embodiment, the predefined volume of liquid 110 may be an electrically conductive and non-adhesive liquid such as alcohol, colored spirit, a liquid colorant and the like. The predefined volume of liquid 110 within the indicator 194, may be filled such that, an air-bubble may be formed within the indicator 104. In an embodiment, the air bubble may be construed as the pointer 105. The pointer 105 may be in contact with at least one surface of the indicator 194. The pointer 105 displaces with respect to orientation of the indicator 104. For example, if the indicator 104 is positioned in-line to a horizontal axes or horizontal surface, then the pointer 105 may be located at central portion of the indicator 104, thereby determining and indicating influence of tilt. In an embodiment, if the indicator 104 is positioned on an inclined surface, then the pointer 105 displaces and orients within the indicator 104 with respect to an angle associated to the inclined surface to depict influence of tilt.

Further, referring to FIG. 2, the enclosed vial surface of the indicator 104, includes one or more electrical touch sensitive surfaces 109a, 109b such that, electrical current flows between the one or more electrical touch sensitive surfaces to the prearranged pixel formation 115 through the electrically conductive fluid 110. In an embodiment, the pointer 105 may be in constant contact with, the one or more pixels in the pixel formation 115 based on the orientation of the indicator 104, thus causing only those pixels to be non-conductive. The electrical touch sensitive surfaces 109a, 109b may be equipped with plurality of sensors 111, to detect position of the pointer 105 within the indicator 104. In some embodiment, the plurality of sensors 111 may be arranged in myriad of patterns on the one or more electrical touch sensitive surfaces 169a, 109b, to determine the position of the pointer 105. In some embodiment, the plurality of sensors 111 can be provided on the reference axes X-Y and the reference point P to determine position and co-incidence of the pointer 105 within the indicator 104. The plurality of sensors 111 generates electrical signals when the pointer 105 contacts the one or more pixels in the pixel formation 115 on the electrical touch sensitive surface 109a. The electrical signals are transmitted as input data from the plurality of sensors 111 to the control unit 107, pertaining to position of the pointer 105 within the indicator 104. Once the pointer 105 contacts one sensor of the plurality of sensors 111, the input data from the one sensor of the plurality of sensors 111 is triggered, thereby indicating the control unit 107 about position of the pointer 105 on the one or more electrical touch sensitive surfaces 109a, 109b. The electrical signal received by the control unit 107 may be determined to indicate corresponding position of the pointer 105, on the reference axes X-Y of the display unit 108. Upon projecting the position of the pointer 105 on the reference axes X-Y of the display unit 108, the operator is indicated about angle of tilt of the fastener 101 on the fastening surface, thereby manually correcting the angle of tilt by the operator.

In an embodiment, the indicator 104 of the portable orientation device 100 may be an electronic spirit level such that, the spirit level may be used to determine orientation of the fastener 101, with respect to the surface used for fastening. It is to be understood that, the indicator 104 of the portable orientation device 100 of the present disclosure, may be used in other applications as well, and use as a spirit level should not be construed as any form of limitation of the present disclosure.

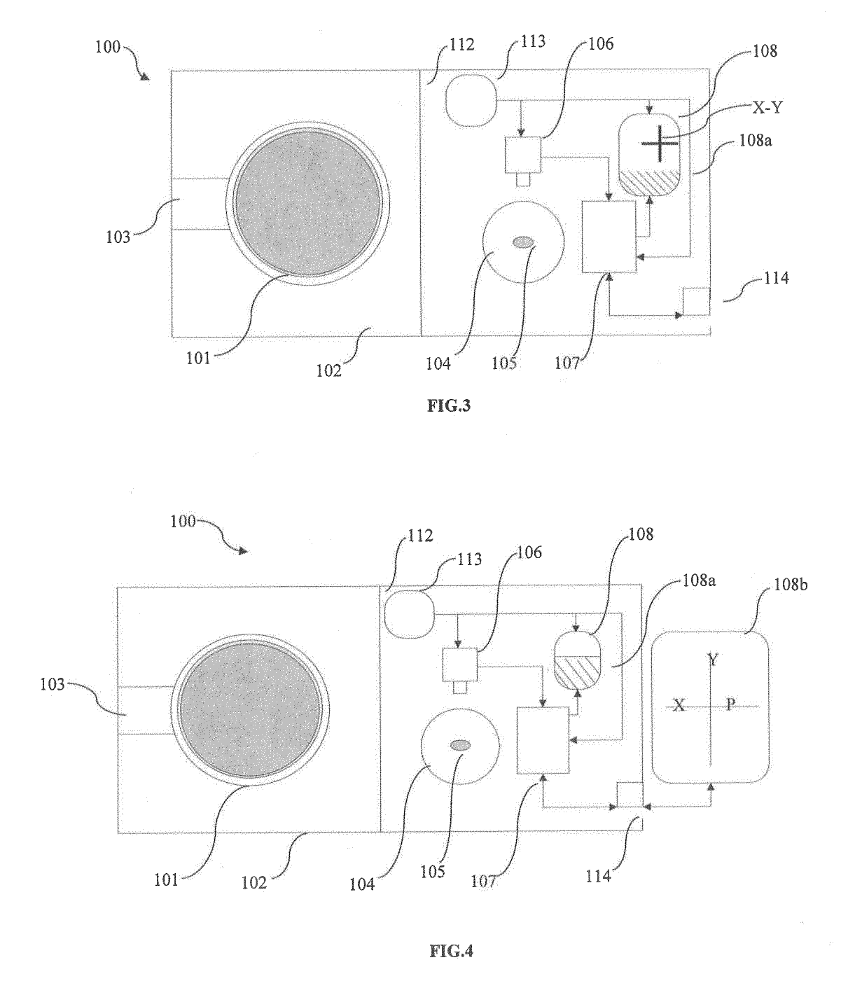

Referring now to FIG. 3, the portable orientation device 100 in accordance with some embodiment of the present disclosure is illustrated. The portable orientation device 100 is provisioned with one or more image capturing units 106 on the base member 102. The one or more image capturing units 106 may be positioned either at top portion of the indicator 104 proximal to one of the electrical touch sensing surface 109a of the one or more electrical touch sensitive surfaces 109a, 109b or at bottom portion of the indicator 104 proximal to one of the electrical touch sensing surface 109b of the one or more electrical touch sensitive surfaces 109a, 109b. The one or more image capturing units 106 captures movement of the pointer 105 confined within the indicator 104. On change in orientation of the fastener 101, the position of the pointer 105 is displaced within the indicator 104 and the same is captured by the one or more image capturing units 106. The one or more image capturing units 106, on capturing position of the pointer 105, generates and transmits an input data to the control unit 107. The control unit 107 receives the input data, transmitted by the one or more image capturing units 106 and transmits an output signal to the display unit 108, which projects the position of the pointer 105 with the reference axes X-Y to the operator. In some embodiment, the one or more image capturing units 106 may be a Red-Green-Blue-Depth (RGB-D) camera, an infrared camera, a motion detector camera and the like.

In some embodiment, the display unit 108 may be interfaced with an audio alert unit 108a, to assist the operator in orienting the fastener 101. The audio alert unit 108a may include an output speaker capable of outputting sound warnings. The audio alert unit 108a may be synchronously networked with the display unit 108 to alert the operator, when deviation in position of the pointer 105 with respect to the reference axes X-Y is determined.

Referring now to FIG. 4, the portable orientation device 100 in accordance with an embodiment of the present disclosure may be associated to a secondary display unit 108b. The secondary display unit 108b may be connected through a connecting unit 114 provided on the electronic circuit board 112. In an embodiment, the secondary display unit 108b may assist the operator to remotely access and determine position of the pointer 105 within the indicator 104 with respect to the reference axes X-Y such that, the operator is able to determine orientation of the fastener 101. In some embodiment, the connecting unit 114 may be a Bluetooth unit, an Ethernet port, an audio-visual port, a wireless networking unit, a hardware connecting port and the like.

In some embodiment, the control unit 107 of the portable orientation device 100 may include specialized processing units such as integrated system (bus) controllers, memory management control units, floating point units, graphics processing units, digital signal processing units, and the like. The processing unit may include a microprocessor, such as AMD Athlon, Duron or Opteron, ARM's application, embedded or secure processors, IBM PowerPC, Intel's Core, Itanium, Xeon, Celeron or other line of processors, and the like. The control unit 107 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), microcontroller, and the like.

In some embodiments, the control unit 107 may be disposed in communication with, one or more memory devices (e.g., RAM, ROM and the like.) via a storage interface. The storage interface may connect to memory devices including, without limitation, memory drives, removable disc drives, and the like., employing connection protocols such as serial advanced technology attachment (SATA), integrated drive electronics (IDE), IEEE-1394, universal serial bus (USB), fiber channel, small computing system interface (SCSI), and the like. The memory drives may further include a drum, magnetic disc drive, magneto-optical drive, optical drive, redundant array of independent discs (RAID), solid-state memory devices, solid-state drives, and the like.

In an embodiment, the portable orientation device 100 may be used to calibrate orientation of the fastener 101, during fastening as well as unfastening from the fastening surface. It is to be understood that, the portable orientation device 100 of the present disclosure, may be used in other applications as well, and use as a portable orientation device 100 for a fastener 101 should not be construed as any form of limitation of the present disclosure.

Advantages of the Embodiment of the Present Disclosure are Illustrated Herein

In an embodiment, the portable orientation device prevents misalignment of the fastener in the fastening hole such that, the secured fastener does not shear due to fatigue stresses.

In an embodiment, orientation of the fastener can be determined remotely by the operator thereby preventing misalignment.

In an embodiment, the portable orientation device uses flexible material to accommodate varying fastener sizes.

The terms “an embodiment”, “embodiment”, “embodiments”, “the embodiment”, “the embodiments”, “one or more embodiments”, “some embodiments”, and “one embodiment” mean “one or more (but not all) embodiments of the inventions)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean, “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true-scope and spirit being indicated by the following claims.

REFERRAL NUMERALS

| Particulars | Numerical |
|---|---|
| Portable orientation device | 100 |
| Fastener | 101 |
| Base member | 102 |
| Cut-out | 103 |
| Indicator | 104 |
| Pointer | 105 |
| Image capturing unit | 106 |
| Control unit | 107 |
| Display unit | 108 |
| Audio alert unit | 108a |
| Secondary display unit | 108b |
| Electrical touch sensitive | 109a and 109b |
| surfaces | |
| Liquid | 110 |
| Plurality of sensors | 111 |
| Electronic circuit board | 112 |
| Power source | 113 |
| Connecting unit | 114 |
| Pixel formation | 115 |
| Reference Axes | X-Y |
| Reference point | P |

What is claimed is:

1. A portable orientation device for a fastener, comprising;
a base member, provisioned with an at least one cut-out, to receive the fastener;
an indicator provisioned on the base member, wherein the indicator comprises a pointer such that,
the pointer displaces within the indicator based on orientation of the fastener;
one or more image capturing units configured on the base member, wherein the one or more image capturing units captures data based on movement of the pointer; and
a control unit interfaced to the one or more image capturing units, receives the data on movement of the pointer from the one or more image-capturing units, wherein the control unit determines position of the pointer, to enable an operator for orienting the fastener.

2. The portable orientation device as claimed in claim 1, wherein the at least one cut-out is configured with a flexible member to accommodate varying shapes of the fastener.

3. The portable orientation device as claimed in claim 1, wherein the indicator is an enclosed vial of predefined shape configurable to contain predefined volume of liquid.

4. The portable orientation device as claimed in claim 3, wherein the pointer is an air bubble formed in the predefined volume of liquid and displaceable within the indicator.

5. The portable orientation device as claimed in claim 1, wherein the indicator is provisioned with an electrical touch sensitive surfaces.

6. The portable orientation device as claimed in claim 5, wherein the electrical touch sensitive surface of the indicator is provisioned with plurality of sensors at predetermined locations to locate position of the pointer.

7. The portable orientation device as claimed in claim 1, comprises a display unit communicatively connected to the control unit, wherein the display unit receives an input signal from the control unit, and enables the operator to observe the position of the pointer, thereby determining orientation of the fastener.

8. The portable orientation device as claimed in claim 7, wherein the display unit is provisioned with reference axes X-Y to assist the operator in aligning the pointer with respect to a reference point P, to orient the fastener.

9. The portable orientation device as claimed in claim 8, wherein the operator manually adjusts the orientation of the fastener until the pointer coincides with the reference point P in the display unit.

10. The portable orientation device as claimed in claim 1, comprises a connecting unit, to connect an external module.

11. The portable orientation device as claimed in claim 1, wherein the one or more image capturing units are positioned on top of the indicator or at bottom of the indicator.

12. The portable orientation device as claimed in claim 1, comprises an electronic circuit board configured on the surface of the base member for operating the control unit, the one or more image capturing units, and the display unit.

13. The portable orientation device as claimed in claim 12, comprises at least one power source to supply power to the electronic circuit board.
